(19) United States
(12) Patent Application Publication
(10) Pub. No.: US 2024/0363916 A1
(43) Pub. Date: Oct. 31, 2024

(54) SECONDARY BATTERY

(71) Applicant: Samsung SDI Co., Ltd., Yongin-si (KR)

(72) Inventors: Jun Hyung LEE, Yongin-si (KR); Jun Sun YONG, Yongin-si (KR); Kwang Soo BAE, Yongin-si (KR)

(21) Appl. No.: 18/471,095

(22) Filed: Sep. 20, 2023

(30) Foreign Application Priority Data
Apr. 27, 2023 (KR) 10-2023-0055281

(51) Int. Cl. H01M 10/613; H01M 10/04; H01M 50/103; H01M 50/119; H01M 50/15

(52) U.S. Cl. CPC H01M 10/613; H01M 10/0413; H01M 50/103; H01M 50/119; H01M 50/15

(57) ABSTRACT

A secondary battery includes: an electrode assembly including a first electrode plate and a second electrode plate exposed on opposite sides, respectively; a can to accommodate the electrode assembly, and having opposite open sides; a first terminal electrically coupled to the first electrode plate of the electrode assembly; a first cap plate to seal one of the open sides of the can, and externally expose the first terminal; a second terminal electrically coupled to the second electrode plate of the electrode assembly; and a second cap plate to seal the other of the open sides of the can, and externally expose the second terminal. The can includes a cooling pad adhered to an inner surface of the can through a first adhesive.

### CROSS-REFERENCE TO RELATED APPLICATION

This application claims priority to and the benefit of Korean Patent Application No. 10-2023-0055281, filed on Apr. 27, 2023, in the Korean Intellectual Property Office, the entire disclosure of which is incorporated by reference herein.

### BACKGROUND

### 1. Field

Aspects of embodiments of the present disclosure relate to a secondary battery.

### 2. Description of Related Art

A secondary battery is a power storage system that provides excellent energy density capable of converting electrical energy into chemical energy and storing the same. Compared to non-rechargeable primary batteries, secondary batteries are rechargeable, and thus, are widely used in various suitable IT devices, such as smart phones, cellular phones, notebooks, and tablet PCs. Recently, interest in electric vehicles has increased to prevent or reduce environmental pollution, and accordingly, high-capacity secondary batteries are being adopted for electric vehicles. These secondary batteries are required to have suitable characteristics, such as high density, high power, and stability.

The above information disclosed in this Background section is for enhancement of understanding of the background of the present disclosure, and therefore, it may contain information that does not constitute prior art.

### SUMMARY

In a can of a prismatic secondary battery, aluminum may typically be used for the can for good cooling performance, but aluminum may be vulnerable to high temperatures, and thus, may be vulnerable to heat propagation when applied to a battery module using a plurality of secondary batteries.

One or more embodiments of the present disclosure are directed to a secondary battery capable of improving thermal propagation safety by including a can made of stainless steel, and capable of improving heat dissipation performance through a heat dissipation pad attached to the inside of the can.

According to one or more embodiments of the present disclosure, a secondary battery includes: an electrode assembly including a first electrode plate and a second electrode plate exposed on opposite sides, respectively; a can to accommodate the electrode assembly, and having opposite open sides; a first terminal electrically coupled to the first electrode plate of the electrode assembly; a first cap plate to seal one of the open sides of the can, and externally expose the first terminal; a second terminal electrically coupled to the second electrode plate of the electrode assembly; and a second cap plate to seal the other of the open sides of the can, and externally expose the second terminal. The can includes a cooling pad adhered to an inner surface of the can through a first adhesive.

In an embodiment, the can may include stainless steel.

In an embodiment, the can may include: a rectangular upper surface extending in a longitudinal direction; a lower surface opposite to the upper surface, extending in the longitudinal direction, and having the same shape as that of the upper surface; and two long side surfaces connecting long sides of the upper surface and the lower surface to each other.

In an embodiment, the can may have a rectangular parallelepiped shape, and the upper surface, the lower surface, and the two long side surfaces of the can may be integrated together.

In an embodiment, the cooling pad may include a plurality of cooling pads attached to the two long side surfaces of the can, respectively.

In an embodiment, a longitudinal length of the cooling pad may be smaller than that of the electrode assembly.

In an embodiment, the cooling pad may be attached to the electrode assembly through a second adhesive on a surface of the cooling pad facing the electrode assembly.

In an embodiment, the first and second adhesives may include an insulating heat transfer material.

In an embodiment, the cooling pad may include fluorine nitride.

In an embodiment, the first electrode plate may be a negative electrode located at an outermost side.

In an embodiment, the can may include a safety vent on a lower surface of the can, and the safety vent may have a smaller thickness than other regions of the can.

### BRIEF DESCRIPTION OF DRAWINGS

The above and other aspects and features of the present disclosure will be more clearly understood from the following detailed description of the illustrative, non-limiting embodiments with reference to the accompanying drawings.

FIG. 1 is a perspective view of a secondary battery according to embodiments of the present disclosure.

FIG. 2 is an exploded perspective view of the secondary battery of FIG. 1, in which a long side surface of a can is removed.

FIG. 3 is a cross-sectional view taken along the line 3-3 of FIG. 1, and a partially enlarged portion of the cross-sectional view.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

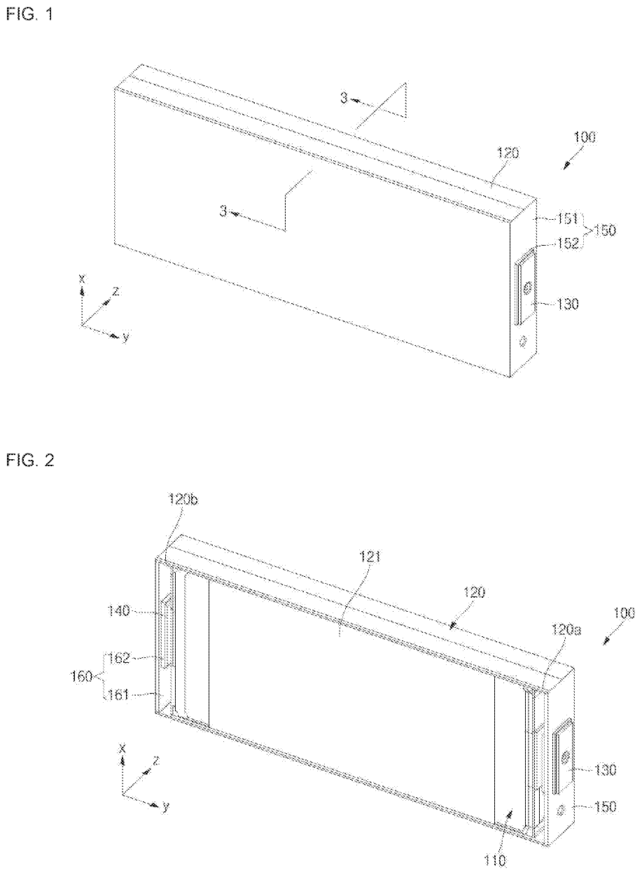

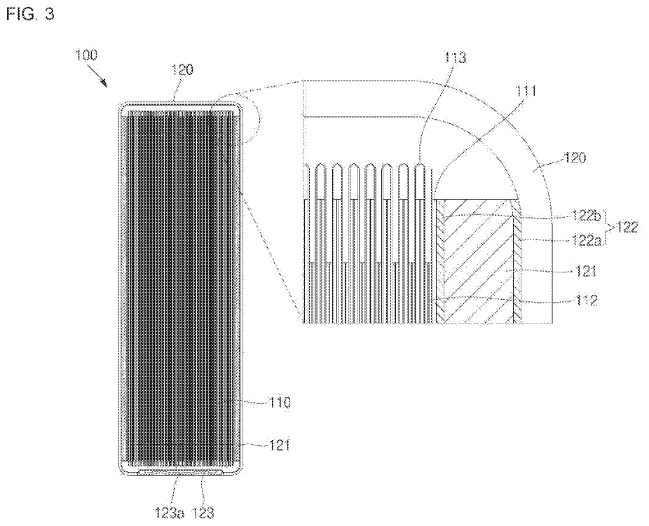

FIG. 1 is a perspective view of a secondary battery according to embodiments of the present disclosure. FIG. 2 is an exploded perspective view of the secondary battery of FIG. 1, in which a long side surface of a can is removed. FIG. 3 is a cross-sectional view taken along the line 3-3 of FIG. 1, and a partially enlarged portion of the cross-sectional view.

Referring to FIGS. 1 to 3, the secondary battery 100 may include an electrode assembly 110, a can 120, a first terminal 130, a second terminal 140, a first cap assembly 150, and a second cap assembly 160.

The electrode assembly 110 may be formed by winding or stacking a laminate of a first electrode plate 111, a separator 113, and a second electrode plate 112, which are formed in a thin plate shape or film shape. When the electrode assembly 110 is a wound laminate, a winding axis may be parallel to the longitudinal direction y of the can 120. In addition, the electrode assembly 110 may be a stack type rather than a winding type, but the shape of the electrode assembly 110 is not limited thereto. In addition, one or more electrode assemblies 110 may be stacked, such that long sides of the electrode assemblies 110 are adjacent to each other, and accommodated in the can 120. The number of electrode assemblies 110 is not particularly limited.

The first electrode plate 111 of the electrode assembly 110 may serve as a negative electrode, and the second electrode plate 112 may serve as a positive electrode. However, the present disclosure is not limited thereto, and the first electrode plate 111 may serve as the positive electrode, and the second electrode plate 112 may serve as the negative electrode.

The first electrode plate 111, which is formed by applying a first electrode active material, such as graphite or carbon, to a first electrode current collector plate made of a metal foil, such as copper, a copper alloy, nickel, or a nickel alloy, may include a first electrode tab (or first uncoated portion) that is a region to which the first electrode active material is not applied. The first electrode tab may be a passage for current to flow between the first electrode plate 111 and a first current collection part (e.g., the first terminal 130). In some examples, when the first electrode plate 111 is manufactured, the first electrode tab may be formed by being cut in advance to protrude to one side, and may protrude more to one side than the separator 113 without separate cutting.

The second electrode plate 112 may be formed by applying a second electrode active material, such as a transition metal oxide, to a second electrode current collector plate made of a metal foil, such as aluminum or an aluminum alloy, and may include a second electrode tab (or second uncoated portion) that is a region to which the second electrode active material is not applied. The second electrode tab may be a passage for current to flow between the second electrode plate 112 and a second current collection part (e.g., the second terminal 140). In some examples, when manufacturing the second electrode plate 112, the second electrode tab may be formed by being cut in advance to protrude to another side (e.g., an opposite side), and may protrude more to the other side than the separator 113 without separate cutting.

In some embodiments, the first electrode tab may be located on the right side of the electrode assembly 110, and the second electrode tab may be located on the left side of the electrode assembly 110. Here, the terms the left side and the right side are used for convenience of explanation based on the secondary battery 100 illustrated in FIGS. 1 and 2, and thus, the present disclosure is not limited thereto. The positions of the first and second electrode tabs may be variously modified and/or variously described, for example, when the secondary battery 100 is rotated to the left and right or up and down. Hereinafter, each component will be described on the basis of the secondary battery 100 as illustrated in FIGS. 1 to 3.

In some examples, the separator 113 is positioned between the first electrode plate 111 and the second electrode plate 112 to prevent or substantially prevent a short circuit, and to enable the movement of lithium ions. The separator 113 may include polyethylene, polypropylene, or a composite film of polyethylene and polypropylene. In addition, the separator 113 may be replaced with an inorganic solid electrolyte, such as a sulfide, an oxide, or a phosphate compound that does not require a liquid or gel electrolyte.

The first electrode tab of the first electrode plate 111 and the second electrode tab of the second electrode plate 112 are positioned at opposite ends of the electrode assembly 110, respectively. In some embodiments, the electrode assembly 110 may be accommodated in the can 120 together with an electrolyte. In some embodiments, the electrolyte may include a lithium salt, such as LiPF6 or LiBF4, in an organic solvent, such as EC, PC, DEC, EMC, or DMC. In addition, the electrolyte may be in a liquid phase or a gel phase. In some embodiments, the electrolyte may be omitted, and an inorganic solid electrolyte may be used.

In addition, the electrode assembly 110 may be located, such that the first terminal 130 and the second terminal 140 are welded to and connected to the first electrode tab of the first electrode plate 111 and the second electrode tab of the second electrode plate 112, respectively, exposed to the opposite sides.

The can 120 may have a hollow or substantially hollow rectangular parallelepiped shape having openings 120a and 120b formed on opposite sides, and the electrode assembly 110 may be inserted into the inside of the can 120 through the openings 120a and 120b.

The can 120 may include upper and lower surfaces of a rectangle extending along the longitudinal direction of the can, and two rectangular long sides connecting the long sides of the upper and lower surfaces to each other, and extending along the longitudinal direction. The can 120 may have the upper surface, the lower surface, and the two long side surfaces that are integrally formed with each other.

In the can 120, the first cap assembly 150 and the second cap assembly 160 may be coupled to both openings 120a and 120b, respectively. The can 120 may be made of a conductive metal, such as stainless steel. Because the can 120 is made of stainless steel, safety against heat propagation may be improved.

The can 120 may include a cooling pad 121 on an inner surface thereof to improve a heat dissipation effect. The cooling pad 121 may be adhered to the inner surface of the can 120 through an adhesive 122. The cooling pad 121 may transfer heat generated due to over-discharge of the electrode assembly 110 to the can 120 to facilitate heat dissipation. The cooling pad 121 may be made of a suitable material capable of conducting heat while blocking electricity. For example, the cooling pad 121 may be made of boron nitride. Boron nitride has characteristics of high thermal stability, high thermal conductivity, electrical insulation, and non-toxicity, and thus, may be suitably used for the cooling pad 120. As another example, the cooling pad 121 may be made of a suitable composite material containing boron nitride. A plurality of the cooling pads 121 may be provided on surfaces of the can 120 that are opposite to (e.g., that face) the long side surfaces of the electrode assembly 110 in the can 120, respectively. In other words, the cooling pad 121 may be provided between the long side surface of the electrode assembly 110 and the long side surface of the can 120.

The length of the cooling pad 121 in the longitudinal direction (e.g., the y direction) of the can 120 may be smaller than that of the long side surface of the electrode assembly 110 in the longitudinal direction (e.g., the y direction). In addition, on the long side of the electrode assembly 110, outer regions adjacent to the first cap assembly 150 and the second cap assembly 160 may face the can 120. The first electrode plate 111 may be positioned on the outermost side of the electrode assembly 110. On the inner surface of the long side of the can 120, an insulating film for electrical insulation from the electrode assembly 110 may be attached to the outer region to which the cooling pad 121 is not attached. In addition, insulating films for electrical insulation from the electrode assembly 110 may also be attached to the upper and lower surfaces of the can 120.

The cooling pad 121 may be in the form of a film that may be attached to the long side of the can 120 through an adhesive 122a. The adhesive 122a may be made of a thermal interface material (TIM) of an insulating material. The adhesive 122a may easily transfer heat from the cooling pad 121 to the can 120, and may bond the cooling pad 121 with the inside of the can 120 in close contact with each other.

In addition, in the cooling pad 121, an adhesive 122b may be further provided on a surface facing the long side surface of the electrode assembly 110. After the electrode assembly 110 is inserted into the can 120, the adhesive 122b may be attached to the cooling pad 121 to be expanded by swelling. In other words, the adhesive 122 may include the adhesive 122a for bonding the cooling pad 121 and the can 120 to each other, and the adhesive 122b for bonding the cooling pad 121 and the electrode assembly 110 to each other.

The cooling pad 121 may be attached to the electrode assembly 110 and the can 120 through the adhesive 122, and thus, heat conduction and dissipation between the electrode assembly 110 and the can 120 may be facilitated.

The can 120 may have a vent hole passing through the lower surface thereof. A safety vent 123 may be installed in the vent hole of the can 120. The safety vent 123 installed in the can 120 may have a plate shape that is thinner than other regions of the can 120. The safety vent 123 may include a notch 123a formed to be opened by a set pressure. As an example, when the internal pressure of the safety vent 123 increases due to an event such as charging or perforation, the notch 123a may be broken to release internal gas and internal heat. The notch 123a may be a thinner area than other regions of the safety vent 123.

The first terminal 130 is made of a metal, and may be electrically connected to the first electrode plate 111 of the electrode assembly 110. The first terminal 130 may pass through a first cap plate 151, which will be described in more detail below, and a seal gasket for electrical insulation and sealing may be interposed between the first terminal 130 and the first cap plate 151. The first terminal 130 may be in contact with and welded to the first electrode tab of the first electrode plate 111 of the electrode assembly 110 inside the first cap plate 151. As another example, the first terminal 130 may be electrically connected to the first electrode tab of the first electrode plate 111 of the electrode assembly 110 through a current collector that is a separate member. The first terminal 130 may be made of copper or a copper alloy. A portion of the first terminal 130 may be exposed and protrude outward from the first cap plate 151.

The second terminal 140 is made of a metal, and may be electrically connected to the second electrode plate 112. The second terminal 140 may pass through a second cap plate 161, which will be described in more detail below, and a seal gasket for electrical insulation and sealing may be interposed between the second terminal 140 and the second cap plate 161. The second terminal 140 may be in contact with and welded to the second electrode tab of the second electrode plate 112 of the electrode assembly 110 inside the second cap plate 161. As another example, the second terminal 140 may be electrically connected to the second electrode tab of the second electrode plate 112 of the electrode assembly 110 through a current collector that is a separate member. The second terminal 140 may be made of aluminum or an aluminum alloy. A portion of the second terminal 140 may be exposed and protrude outward from the second cap plate 161. The second terminal 150 may be symmetrical or substantially symmetrical with the first terminal 130 relative to the can 120.

The first cap assembly 150 may be coupled to the right-side opening 120a of the can 120. In some examples, the first cap assembly 150 may include the first cap plate 151 and a first seal gasket 152. The first cap plate 151 has a flat or substantially flat rectangular plate shape, and may seal the right-side opening 120a of the can 120. The first cap plate 151 may have a rectangular plate shape corresponding to the right-side opening 120a of the can 120. The first cap plate 151 may have a terminal hole penetrating between an outer surface and an inner surface. The first terminal 130 may be inserted into the terminal hole of the first cap plate 151, and may be coupled with the first cap plate 151.

In addition, the first seal gasket 152 may be made of an insulating material, and may be formed between the first cap plate 151 and the first terminal 130 to seal a space between the first cap plate 151 and the first terminal 130. The first seal gasket 152 may prevent or substantially prevent external moisture from penetrating into the secondary battery 100, or may prevent or substantially prevent an electrolyte contained in the secondary battery 100 from leaking to the outside.

After the electrode assembly 110 is accommodated in the can 120, the first cap plate 151 coupled to the first terminal 130 may seal the right-side opening 120a of the can 120. In some embodiments, before the first cap plate 151 seals the can 120, the electrode assembly 110 and the first terminal 130 may be coupled to each other by welding. In addition, after the electrode assembly 110 and the first terminal 130 are coupled to each other, the first cap plate 151 may be coupled to the right-side opening 120a of the can 120. In this case, the first cap plate 151 may be coupled to the right-side opening 120a of the can 120 by welding.

The second cap assembly 160 may be coupled to the left opening 120b of the can 120. In some examples, the second cap assembly 160 may include a second cap plate 161 and a second seal gasket 162. The second cap assembly 160 may have the same or substantially the same shape and structure as those of the first cap assembly 150. In addition, the coupling shape and structure of the second cap assembly 160 and the second terminal 140 may be the same or substantially the same as that of the first cap assembly 150 and the first terminal 130. However, the coupling shape of the second cap assembly 160 and the second terminal 140 may be symmetrical or substantially symmetrical to that of the first cap assembly 150 and the first terminal 130 with respect to the can 120.

In the secondary battery 100, the can 120 may be made of stainless steel. When a plurality of secondary batteries 100 are electrically connected to each other in the form of a battery module, even when a thermal runaway and the like occurs in an adjacent one of the secondary batteries 100, the can 120 may prevent or partially prevent thermal propagation, thereby, improving safety. In addition, in the secondary battery 100 according to one or more embodiments of the present disclosure, heat propagation safety may be improved through the can 120 made of stainless steel, and heat dissipation performance may be improved through the cooling pad 121 attached to the inside of the can 120.

As described above, in the secondary battery according to one or more embodiments of the present disclosure, heat propagation safety may be improved through a can made of stainless steel, and heat dissipation performance may be improved through a heat dissipation pad attached to the inside of the can.

In addition, in the secondary battery according to one or more embodiments of the present disclosure, a first terminal and a second terminal are provided on opposite sides thereof, respectively, and thus, even when a plurality of secondary batteries are combined together in a module form, cooling members may be coupled to the upper and lower regions of the can, respectively, thereby reducing deterioration of the secondary batteries and improving cooling performance.

In addition, in the secondary battery according to one or more embodiments of the present disclosure, a first terminal and a second terminal are provided on opposite sides thereof, respectively, and thus, when a number of secondary batteries are combined together in a module form, a charge/discharge current flows along each terminal from both sides, thereby improving deterioration due to the charge/discharge current and achieving high space utilization.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A secondary battery comprising:
an electrode assembly including a first electrode plate and a second electrode plate exposed on opposite sides, respectively;
a can to accommodate the electrode assembly, and having opposite open sides;
a first terminal electrically coupled to the first electrode plate of the electrode assembly;
a first cap plate to seal one of the open sides of the can, and externally expose the first terminal;
a second terminal electrically coupled to the second electrode plate of the electrode assembly; and
a second cap plate to seal the other of the open sides of the can, and externally expose the second terminal,
wherein the can comprises a cooling pad adhered to an inner surface of the can through a first adhesive.

2. The secondary battery as claimed in claim 1, wherein the can comprises stainless steel.

3. The secondary battery as claimed in claim 1, wherein the can comprises:
a rectangular upper surface extending in a longitudinal direction;
a lower surface opposite to the upper surface, extending in the longitudinal direction, and having the same shape as that of the upper surface; and
two long side surfaces connecting long sides of the upper surface and the lower surface to each other.

4. The secondary battery as claimed in claim 3, wherein the can has a rectangular parallelepiped shape, and the upper surface, the lower surface, and the two long side surfaces of the can are integrated together.

5. The secondary battery as claimed in claim 3, wherein the cooling pad comprises a plurality of cooling pads attached to the two long side surfaces of the can, respectively.

6. The secondary battery as claimed in claim 5, wherein a longitudinal length of the cooling pad is smaller than that of the electrode assembly.

7. The secondary battery as claimed in claim 3, wherein the cooling pad is attached to the electrode assembly through a second adhesive on a surface of the cooling pad facing the electrode assembly.

8. The secondary battery as claimed in claim 7, wherein the first and second adhesives comprise an insulating heat transfer material.

9. The secondary battery as claimed in claim 1, wherein the cooling pad comprises fluorine nitride.

10. The secondary battery as claimed in claim 1, wherein the first electrode plate is a negative electrode located at an outermost side.

11. The secondary battery as claimed in claim 1, wherein the can comprises a safety vent on a lower surface of the can, and the safety vent has a smaller thickness than other regions of the can.
